(19) United States
(12) Patent Application Publication
(10) Pub. No.: US 2015/0378800 A1
(43) Pub. Date: Dec. 31, 2015

(54) STORAGE DEVICE AND STORAGE DEVICE CONTROL METHOD

(71) Applicant: Hitachi, Ltd., Tokyo (JP)

(72) Inventors: Akifumi SUZUKI, Tokyo (JP); Atsushi KAWAMURA, Tokyo (JP)

(21) Appl. No.: 14/233,939

(22) PCT Filed: Mar. 19, 2013
(86) PCT No.: PCT/JP2013/057771

§ 371 Date: Jan. 21, 2014

(51) Int. Cl. G06F 11/07; G06F 3/06

(52) U.S. Cl. CPC G06F 11/076; G06F 11/073; G06F 11/0793; G06F 3/0619; G06F 3/0653; G06F 3/0679

(57) ABSTRACT

The degree of deterioration of each physical storage area in a non-volatile memory is evaluated without interrupted operation of a storage device. The storage device includes a non-volatile memory configured to include a plurality of physical storage areas and a controller. The controller calculates the degree of deterioration of each of a plurality of specific physical storage areas by performing an evaluation process of evaluating the plurality of specific physical storage areas part by part over all of the plurality of specific physical storage areas and determines whether to use the corresponding physical storage areas based on the calculated degree of deterioration. In the evaluation process, the controller selects a part of the plurality of specific physical storage areas writes predetermined evaluation data on the physical storage area group, reads the evaluation data and calculates the degree of deterioration based on the read evaluation data.

### TECHNICAL FIELD

The present invention relates to a storage device that includes a non-volatile memory.

### BACKGROUND ART

Storage devices such as solid state drives (SSDs) using a non-volatile memory such as flash memories (FMs) as a storage medium have been known. The storage devices including the FMs are used for high-speed input/output (IO) processing of systems because of excellent processing performances of random read and random write compared to a hard disk drive (HDD).

An increase in use of the storage devices including the FMs is attributed to low prices of FMs. The low prices of FMs have been achieved due to advance in miniaturization and use of multi-valued technologies. However, the advance in miniaturization and the use of the multi-valued technologies considerably degrade the quality of the FMs.

FMs are devices deteriorating due to erasure (rewriting). The degradation of the quality of the FMs reduces an upper limit value (rewritable times) of the number of erasures. For this reason, storage devices including FMs have a wear leveling function of leveling the number of erasures in order to prevent only some of a plurality of managed physical storage areas from deteriorating and being unusable. Further, storage devices including FMs have a function of assigning an error correcting code (ECC) to recorded data and correcting the recorded data at the time of reading in order to correct an error bit (a bit varied from a stored value) occurring in a physical storage area of an FM. Storage devices having a refresh function of reading recorded data after a given period elapses from recording of data, correcting the data by an ECC, and then recording the data again have also been known.

As one of the examples of a measurement value used for high-reliable control, the number of erasures of a physical storage area can be exemplified. The storage devices including the FMs comprehend deterioration in each physical storage area by counting and managing the number of erasures of each physical storage area. In general, non-volatile memory (NVM) modules including FMs ensure the reliability of the NVM modules by configuring the upper limit value of the number of erasures and causing physical storage areas of which the number of erasures reaches the upper limit value to be unusable.

Since there is a natural quality difference between FM chips, the deterioration differs in the FM even when the number of erasures is the same. Further, the deterioration differs also according to a cumulative use environment of the physical storage areas. For example, the physical storage areas subjected to rewriting at shorter intervals deteriorate further than the physical storage areas subjected to rewriting at longer intervals. For this reason, in the physical storage areas, a variation in the acquired deterioration occurs in proportion to a use time. In order to ensure sufficient reliability of an NVM module in spite of the variation in the deterioration, the upper limit value of the number of erasures is determined to maintain the reliability of the FM on the assumption that an FM with naturally poor quality is repeatedly subjected to rewriting under a use environment (worst case) in which the deterioration progresses most rapidly. When the number of erasures is equal to or larger than the upper limit value, the FM is inhibited from being used.

The restriction on the number of erasures of the FM by the upper limit value may cause the use of an FM with a naturally excellent quality or an FM used under the condition relaxed more than the worst case to be uniformly restricted. For this reason, the restricted number of erasures may decrease further than the number of erasures naturally usable in the entire NVM module.

A technology for performing special writing on a storage area and estimating deterioration by counting the number of error bits occurring in the writing (for example, see PTL 1).

### CITATION LIST

### Patent Literature

[PTL 1]

US Patent Specification No. 8085586

### SUMMARY OF INVENTION

### Technical Problem

During the estimating of the deterioration, a storage device estimating the deterioration through the special writing may not be accessed by a high-order apparatus. Accordingly, whenever the deterioration is estimated, access to the storage device may be interrupted.

### Solution to Problem

In order to resolve the above-mentioned problem, a storage device according to an aspect of the invention includes: a non-volatile memory configured to include a plurality of physical storage areas; and a controller configured to be coupled to the non-volatile memory. The controller calculates the degree of deterioration of each of a plurality of specific physical storage areas among the plurality of physical storage areas by performing an evaluation process of evaluating the plurality of specific physical storage areas part by part over all of the plurality of specific physical storage areas and determines whether to use the corresponding physical storage areas based on the calculated degree of deterioration. In the evaluation process, the controller selects a part of the plurality of specific physical storage areas as a physical storage area group in a predetermined order of the physical storage areas, moves data in the physical storage area group, erases the physical storage area group, writes predetermined evaluation data on the physical storage area group, reads the evaluation data from the physical storage area group after elapse of a stored neglect time from the time of writing the evaluation data, and calculates the degree of deterioration of a designated area which is each physical storage area in the physical storage area group based on the read evaluation data.

### Advantageous Effects of Invention

According to the aspect of the invention, it is possible to evaluate the degree of deterioration in each physical storage area in a non-volatile memory without interruption of a storage device.

### BRIEF DESCRIPTION OF DRAWINGS

[FIG. 1]

FIG. 1 is a diagram schematically illustrating a variation in the degree of deterioration in physical storage areas in an FM.

[FIG. 2]

FIG. 2 is a diagram illustrating the configuration of a computer system according to an embodiment of the invention.

[FIG. 3]

FIG. 3 is a diagram illustrating the configuration of an NVM module 111.

[FIG. 4]

FIG. 4 is a diagram illustrating the configuration of an FM 220.

[FIG. 5]

FIG. 5 is a diagram illustrating the configuration of a physical block 302.

[FIG. 6]

FIG. 6 is a diagram illustrating the configuration of a physical page 401.

[FIG. 7]

FIG. 7 is a diagram illustrating a logical and physical conversion table 700.

[FIG. 8]

FIG. 8 is a diagram illustrating a block management table 800.

[FIG. 9]

FIG. 9 is a flowchart of a deterioration degree regular evaluation process.

[FIG. 10]

FIG. 10 is a flowchart of a block deterioration degree evaluation process.

[FIG. 11]

FIG. 11 is a diagram illustrating control of a read voltage at the time of evaluation.

[FIG. 12]

FIG. 12 is a diagram illustrating a deterioration degree point estimation table 1100.

[FIG. 13]

FIG. 13 is a diagram illustrating a management screen.

### DESCRIPTION OF EMBODIMENTS

Hereinafter, embodiments of the invention will be described with reference to the drawings.

In the following description, information of the invention will be described using expressions such as “aaa table,” “aaa list,” “aaa DB,” and “aaa queue.” However, the information may be expressed using other data structures than the table, the list, the DB, the queue, and the like. Therefore, to indicate no dependency on the data structures, “aaa table,” “aaa list,” “aaa DB,” “aaa queue,” and the like are referred to “aaa information” in some cases.

When the content of each information item is described, expressions such as “identification information,” “identifier,” “first name,” “last name,” and “ID” are used, but they can be substituted with each other.

In the following description, the description is made using a “program” as a subject. However, since a given process is performed using a memory and a communication port (communication control device) by causing a processor to execute a program, the description may be made assuming the processor to be used as a subject. A part or the entirety of a program may be realized by dedicated hardware.

Various programs may be installed in a program distribution server or a storage device using a computer-readable storage medium.

The invention is not limited to embodiments to be described below. In the embodiments, an FM such as a NAND flash memory is used as a non-volatile memory. However, the invention is applicable to a non-volatile memory deteriorating due to rewriting, such as an FM.

### (1) Control Method of Stopping Use of Physical Storage Areas

An NVM module according to this embodiment restricts the use of physical storage areas according to the degree of deterioration of the physical storage areas estimated from a tendency of an increase in error bits regardless of the number of erasures. In general, the NVM module such as an SSD performs a process of stopping the use of the physical storage areas of which the number of erasures reaches a prescribed number of erasures (for example, ten thousand times). The NVM module according to this embodiment continuously uses the physical storage areas for which it is determined that the reliability can be maintained based on the tendency of the increase in the error bits of the physical storage areas, even when the number of erasures is any value. On the other hand, although the number of erasures does not reach the upper limit value, the NVM module according to this embodiment stops the use of the physical storage areas for which it is determined that the reliability may not be maintained based on the tendency of the increase in the error bits of the physical storage areas.

In this embodiment, physical blocks are used as units of the erasure of the physical storage areas and the estimation of the degree of deterioration or the stop of the use is performed using physical blocks as units. However, the estimation of the degree of deterioration or the stop of the use may be performed using other physical storage areas such as a predetermined number of physical blocks as the units.

Hereinafter, a variation in the degree of deterioration of an FM will be described.

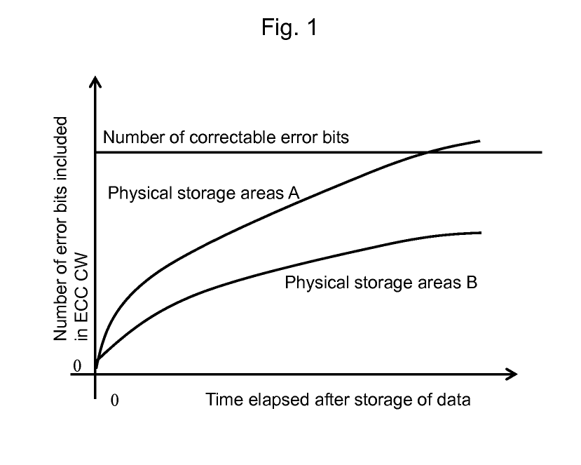

FIG. 1 schematically illustrates the variation in the degree of deterioration of the physical storage areas in the FM. The variation in the degree of deterioration of the FM includes a variation in a natural quality (ease of deterioration) and a variation in an acquired deterioration. In the drawing, the horizontal axis represents a time elapsed after data is recorded on the FM and the vertical axis represents the number of error bits included in an ECC code word (CW) recorded on the FM. The drawing also illustrates the number of correctable error bits which is the number of error bits correctable by an ECC.

In the FM, the number of error bits included in the ECC CW increases, as the time elapsed after the recording of the data passes. For this reason, a storage device using the FM is able to correct error bits equal to or less than a predetermined number of correctable error bits by assigning an ECC to data. When the number of error bits of a certain physical storage area detected by the ECC is equal to or larger than the predetermined error bit number upper limit value, the NVM module stops use of the physical storage area. When a physical storage area A with the high degree of deterioration is compared with a physical storage area B with the degree of deterioration lower than that of the physical storage area A, an increase speed of the error bits of the physical storage area A is higher than an increase speed of the error bits of the physical storage area B. The increase speed of the error bits is generally known to depend on the number of erasures. However, even when a variation in the quality of the FM is large and the same number of erasures is used, the increase speed of the error bits differs between the physical storage area A and the physical storage area B. That is, the number of erasures is useful as a standard of the degree of deterioration to some extent, but does not directly reflect a tendency of the increase in the error bits affecting reliability of the FM.

Most of the causes to lose data recorded on an FM 220 are leakage of electrons due to deterioration in the FM 220. For this reason, the NVM module according to this embodiment acquires the tendency of the increase in the error bits for each physical storage area and manages a deterioration degree point obtained from the tendency of the increase as a substitution for the number of erasures. The deterioration degree point of a physical storage area refers to a value that indicates a magnitude of deterioration of the physical storage area and is obtained by converting the magnitude of deterioration into the number of erasures. The NVM module according to this embodiment determines whether a physical storage area can be used based on the deterioration degree point. The NVM module according to this embodiment levels the deterioration degree points by performing control such that the physical storage areas with relatively smaller deterioration degree points are preferentially selected as the physical storage areas on which new data and updated data are recorded at the time of recording of data.

### (2) Configuration of Storage Apparatus

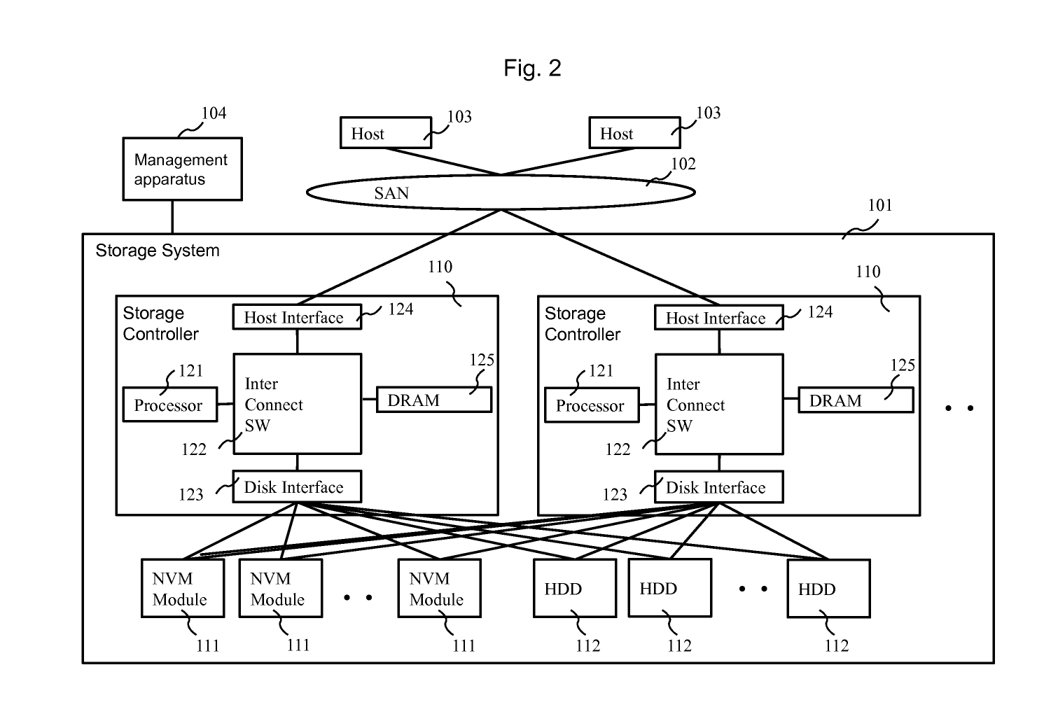

FIG. 2 illustrates the configuration of a computer system according to this embodiment of the invention. The computer system includes a storage apparatus 101, hosts 103, and a management apparatus 104. The storage apparatus 101 is coupled to the hosts 103 via a storage area network (SAN).

The storage apparatus 101 includes a plurality of storage controllers 110. The storage apparatus 101 further includes a plurality of storage devices such as a plurality of (for example, 16) NVM modules 111 and a plurality of (for example, 120) HDDs 112. The storage apparatus 101 may include one storage controller 110, may include one NVM module 111, or may not include the HDD 112. The NVM module 111 is, for example, an SSD. The NVM module 111 is illustrated as a final storage medium in FIG. 2, but may be used as a cache.

The storage controller 110 includes a host interface 124 that performs coupling with the host 103 and a disk interface 123 that performs coupling with a storage device. The host interface 124 is, for example, a device that corresponds to a protocol such as a fibre channel (FC), an internet small computer system interface (iSCSI), or a fibre channel over Ethernet (registered trade name) (FCoE). A disk interface 107 is, for example, a device that corresponds to a protocol such as an FC, a serial attached SCSI (SAS), a serial advanced technology attachment (SATA), or a peripheral component interconnect (PCI)-Express.

The storage controller 110 further includes a processor 121, a memory 125 such as a dynamic random access memory (DRAM), and an inter-connect switch 122.

The inter-connect switch 122 controls communication among the processor 121, the memory 125, the host interface 124, and the disk interface 123.

The memory 125 stores a program and data used to control the storage apparatus 101. The processor 121 operates based on the program and the data stored in the memory 125 and performs a read/write request to a storage device (final storage device) such as the NVM module 111 or the HDD 112 in response to the read/write request from the host 103.

In this embodiment, the NVM module 111 is coupled to the storage controller 110 via the disk interface 123, but the present invention is not limited to this example. For example, the NVM module 111 may be coupled directly to the inter-connect switch 122 via a PCI-Express.

The storage controller 110 has a function of creating a redundant array inexpensive disk (RAID) parity and a function of restoring data by the RAID parity and manages the plurality of NVM modules 111 or the plurality of HDDs 112 as an RAID group in an arbitrary unit. The storage controller 110 divides the RAID group into logical units (LUs) in an arbitrary unit and presents the logical units as logical storage areas to the host 103.

The storage controller 110 creates a parity according to an RAID configuration designated at the time of reception of a write request from the host 103 to the LU and writes the parity on the storage device. The storage controller 110 checks whether data is lost after reading of data from the storage device at the time of reception of a read request from the host 103 to the LU, restores the data using the RAID parity when it is detected that the data is lost, and transmits the restored data to the host 103.

The storage controller 110 has a function of monitoring and managing an error, a use status, an operation status, and the like of the storage device.

The management apparatus 104 is coupled to the plurality of storage controllers 110 via a network. The network is, for example, a local area network (LAN). In this case, the storage controller 110 includes, for example, a network interface. The LAN is coupled to the network interface, and thus the network interface is coupled to the inter-connect switch 122. The management apparatus 104 may be coupled to the plurality of storage controllers 110 via an SAN 102.

The NVM module 111 is a storage device to which the invention is applied. The NVM module 111 is coupled to the plurality of disk interfaces 123. The NVM module 111 stores data transmitted in response to a write request from the storage controller 110, takes out the stored data in response to a read request, and transmits the data to the storage controller 110. At this time, the disk interface 107 designates a logical storage position made by the read/write request by a logical address (hereinafter, referred to as a logical block address (LBA)). The plurality of NVM modules 111 are divided into a plurality of RAID configurations by the storage controller 110 to be managed, and thus are managed as configurations in which lost data can be restored when the data is lost. Each of the plurality of NVM modules 111 may be independently managed.

The HDD 112 is coupled to the plurality of disk interfaces 123, as in the NVM module 111. The HDD 112 stores data transmitted in response to a write request from the storage controller 110, takes out the stored data in response to a read request, and transmits the data to the storage controller 110. At this time, the disk interface 123 designates a logical storage position made by the read/write request by a logical address (hereinafter, referred to as a LBA). The plurality of HDDs 112 are divided into the plurality of RAID configurations to be managed, and thus are structured such that lost data can be restored when the data is lost.

The host interface 124 is coupled to the host 103 via the SAN 102. The plurality of storage controllers 110 may be coupled to each other via coupling paths used to communicate data or control information one another.

The host 103 is, for example, a computer or a file server that serves as a core of a business system. The host 103 has hardware resources such as a processor, a memory, a network interface, and a local input/output device and has software resources such as device drivers, an operating system (OS), and application programs. The host 103 performs communication with the storage apparatus 101 and a read/write request of data by causing the processor to execute various programs. The host 103 acquires management information such as a use status and an operation status of the storage apparatus 101 by causing the processor to execute various programs. The host 103 can perform changing by designating management units of the storage devices or a method of controlling the storage device in the storage apparatuses 101 and configuring of data compression.

The management apparatus 104 is a computer that has hardware resources such as a processor, a memory, a network interface, and a local input/output device and has software resources such as a management program. The management apparatus 104 acquires information from the storage apparatus 101 and displays a management screen by causing the processor to execute the management program. A system manager monitors the storage apparatus 101 and configures an operation using the management screen displayed in the management apparatus 104.

Hitherto, the configuration of the computer system according to this embodiment has been described.

### (3) Configuration of NVM Module 111

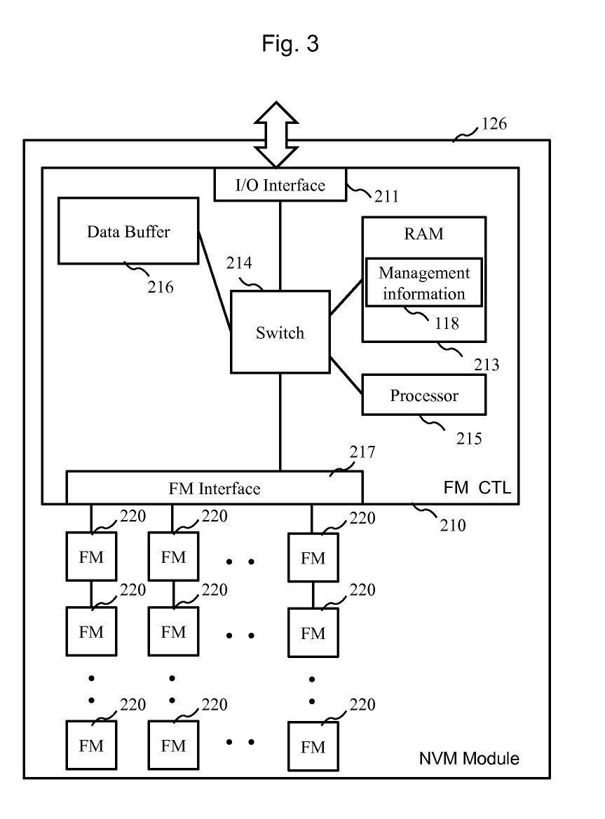

FIG. 3 illustrates the configuration of the NVM module 111. The NVM module 111 includes an FM controller 210 and a plurality of (for example, 32) FMs 220.

The FM controller 210 includes a processor 215, a random access memory (RAM) 213, a data buffer 216, an I/O interface 211, an FM interface 217, and a switch 214.

The switch 214 is coupled to the processor 215, the RAM 213, the data buffer 216, the I/O interface 211, and the FM interface 217 and transmits data by routing the data therebetween based on an address or an ID.

The I/O interface 211 is coupled to the disk interface 107. When making a read/write request, a request target LBA, and a write request, the I/O interface 211 receives write data from the storage controller 110 and records the write data on the RAM 213. The I/O interface 211 receives an indication from the storage controller 110 and issues an interrupt to the processor 215. The I/O interface 211 receives a command for control of the NVM module 111 from the storage controller 110 and notifies the storage controller 110 of an operation status, a use status, a current configured value, and the like of the NVM module 111 according to the command.

The RAM 213 stores a program, management information 118, or the like.

The processor 215 controls the entire FM controller 210 based on the program and the management information stored in the RAM 213. The processor 215 monitors the entire FM controller 210 by acquiring regular information and using an interrupt reception function.

The data buffer 216 stores temporary data during a data transmission process in the FM controller 210.

The FM 220 is, for example, an FM chip. A chip number is attached to each of the plurality of FMs 220. A physical block number is attached to each of the plurality of physical blocks in the FM 220. A physical page number is attached to each of the plurality of physical pages in the physical block.

The FM interface 217 is coupled to the FMs 220 via a plurality of (for example, 16) buses or chip enable (CE) signal lines. A plurality of (for example, 2) FMs 220 are coupled to each bus and the FM interface 217 independently controls the plurality of FMs 220 coupled to the same bus using CE signals.

The FM interface 217 operates in response to a read/write request indicated from the processor 215.

The FM interface 217 includes an ECC creation circuit, a data loss detection circuit by an ECC, and an ECC circuit including an ECC correction circuit. When data is written, the ECC creation circuit adds an ECC to the data and writes the data. When data is read, the data loss detection circuit checks read data from the FM 220. When it is detected that the data is lost, the ECC correction circuit performs correcting of data.

When a read request is received from the storage controller 110 which is a high-order apparatus, the processor 215 reads stored data from the FM 220 via the FM interface 217 and transmits the data to the data buffer 216. When a write request is received from the high-order apparatus, data to be stored is read from the data buffer 216 via the FM interface 217 and is transmitted to the FM 220. The processor 215 designates a request target using the chip number, the physical block number, and the physical page number with regard to the FM interface 217.

The switch 214, the I/O interface 211, the processor 215, the data buffer 216, and the FM interface 217 described above may be structured as an application specific integrated circuit (ASIC) or a field programmable gate array (FPGA) in one semiconductor element or may be structured by coupling a plurality of separate dedicated integrated circuits (ICs) to each other.

The RAM 213 is specifically a volatile memory such as a DRAM. The RAM 213 stores management information regarding the FM 220, a transmission list including transmission control information for direct memory access (DMA), or the like. The RAM 213 may be structured to have some or all of the functions of the data buffer 216 that stores data.

Hitherto, the configuration of the NVM module 111 has been described. The NVM module 111 according to this embodiment includes the FMs 220, but the invention is not limited to the FMs 220. The NVM module 111 may include a non-volatile memory such as a phase change RAM or a resistance RAM.

Hereinafter, the FM 220 will be described.

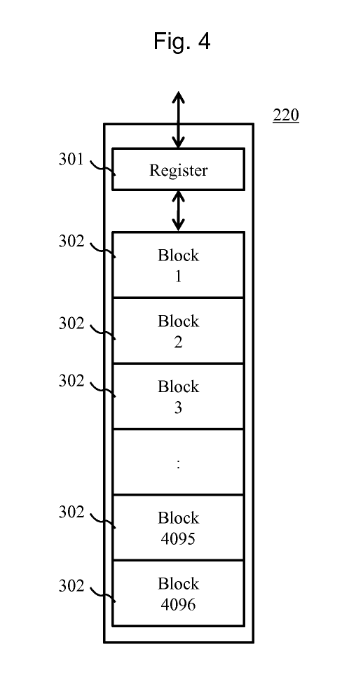

FIG. 4 is a diagram illustrating the configuration of the FM 220. A physical storage area in the FM 220 includes a plurality (for example, 4096) of physical blocks 302. Data stored in the physical storage area is erased in units of the physical blocks 302. The FM 220 includes an I/O register 301. The I/O register 301 is a register that has a storage capacity equal to or larger than a physical page size (for example, 8 KB).

The FM 220 operates according to an indication of a read/write request from the FM interface 217.

In a write operation, the FM 220 first receives a write command and the physical block number and the physical page number of a request target from the FM interface 217. Next, write data transmitted from the FM interface 217 is stored in the I/O register 301. Thereafter, the FM 220 writes the data stored in the I/O register 301 on a physical page in the designated physical block 302.

In a read operation, the FM 220 first receives a read command and the physical block number and the physical page number of a request target from the FM interface 217. Next, the data stored in the physical page in the designated physical block 302 is read and stored in the I/O register 301. Thereafter, the FM 220 transmits the data stored in the I/O register 301 to the FM interface 217.

Hereinafter, the physical block 302 will be described.

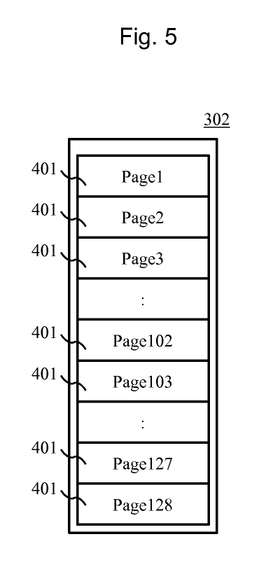

FIG. 5 is a diagram illustrating the configuration of the physical block 302. The physical block 302 is divided into a plurality (for example, 128) of physical pages 401. Reading of the stored data or writing of the data is processed in units of the physical pages 401. Since an order in which the physical pages 401 in the physical block 302 are programmed (written) is fixed, the programming has to be performed in the order of physical page number. Overwriting of data on the written page is forbidden. Therefore, when the physical block 302 to which the physical page 401 belongs is not erased, the physical page 401 is not programmable again.

Hereinafter, the physical page 401 will be described.

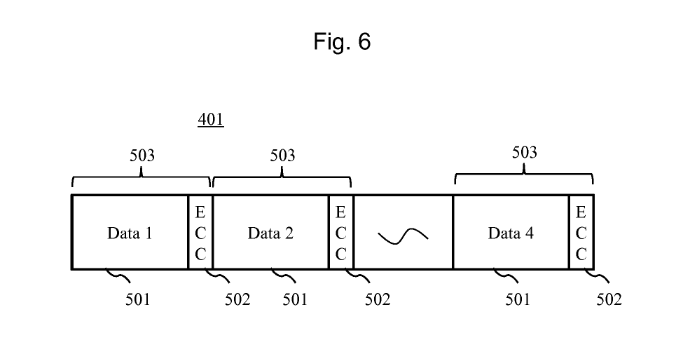

FIG. 6 is a diagram illustrating the configuration of the physical page 401. The physical page 401 stores data of a given number of bits (for example, 4 KB). The physical page 401 stores data 501 and ECCs 502 added to the data 501 by the FM interface 217. The ECC is stored in the rear of data to be protected (hereinafter, referred to as protection data) so as to be adjacent to the data. For example, the data 501 which is protection data and the ECC 502 added thereto are combined to configure one ECC code word (CW) 503.

The configuration in which four ECC CWs 503 are stored in one physical page 401 has been described here, but the number of ECC CWs may be stored according to a physical page size or the intensity (the number of correctable error bits) of the ECC. Here, a data loss error (uncorrectable error) occurs when the number of error bits per ECC CW 503 exceeds the number of correctable error bits.

In the following description, the “physical block” is simply referred to as a “block” and the “physical page” is simply referred to as a “page” in some cases.

Hitherto, the configuration of the NVM module 111 has been described.

### (4) Management Information 118 of NVM Module 111

Hereinafter, the management information 118 used for control by the NVM module 111 will be described. The management information 118 includes a logical and physical conversion table and block management information.

Here, a logical and physical conversion table 700 used to convert a logical address (LBA) into a physical address (physical block address (PBA)) among the management information used by the NVM module 111 will be described.

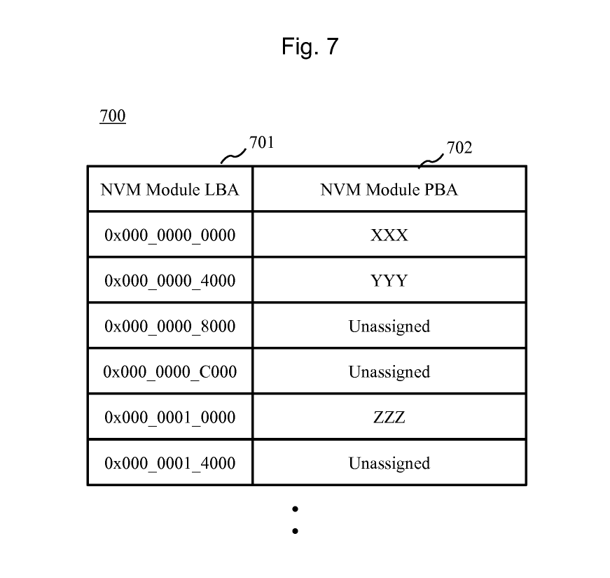

FIG. 7 is a diagram illustrating the logical and physical conversion table 700. The logical and physical conversion table 700 is created by the processor 215 and is stored in the DRAM 213. The logical and physical conversion table 700 includes an NVM module LBA 701 and an NVM module PBA 702 as fields. In the following description, the NVM module LBA is simply referred to as an LBA and the NVM module PBA is simply referred to as a PBA in some cases. The logical and physical conversion table 700 according to this embodiment includes entries of all of the pages used as user areas in the NVM module 111.

The processor 215 receives the NVM module LBA which is a target of a read/write request from the high-order apparatus, and then acquires the NVM module PBA indicating a place in which actual data is stored from the NVM module LBA based on the logical and physical conversion table 700. Through the logical and physical conversion, the processor 215 processes write updating of data on the same NVM module LBA as a storage destination of the data as write of data on an NVM module PBA different from the storage destination, when overwriting of the data is updated. After the write, the processor 215 realizes the overwriting of the data by assigning the PBA on which the update data is written to the LBA in the logical and physical conversion table 700. In this embodiment, efficient use of the physical storage capacity of the NVM module 111 is designed by assigning the PBA only to the LBA area in which the recorded data is present based on the logical and physical conversion table 700.

The LBA 701 is a field in which the logical storage areas provided by the NVM module 111 are arranged in order in units of 16 KB (logical pages). This represents that the NVM module 111 according to this embodiment manages matching of the LBA 701 and the PBA 702 in units of 16 KB. The invention is not limited to the management of matching of the LBA 701 and the PBA 702 in the units of 16 KB.

The PBA 702 stores information indicating specific physical storage areas of all of the FMs 220 managed by the NVM module 111. In this embodiment, addresses separated in the units of 16 KB (physical pages) are used. In this example, a PBA value, “XXX,” can be matched with an LBA value, “0x000_{—}0000_{—}0000.” This PBA value is an address uniquely indicating the physical storage area of the FM 220 in the NVM module 111 and may indicate a chip number in the NVM module 111, a block number in the chip, or a page number in the block. For example, when receiving the LBA value, “0x000_{—}0000_{—}0000,” as a read request destination address, the processor 215 acquires the PBA value, “XXX,” of the physical read destination in the NVM module 111 based on the logical and physical conversion table 700.

When the PBA matched with the LBA is not present, a value indicating that a physical value is “unassigned” is stored in the PBA 702.

The NVM module 111 can assign the PBA to the LBA freely using the logical and physical conversion table 700. Thereafter, a PBA area (page) matched with the LBA based on the logical and physical conversion table 700 is sometimes referred to as an “effective PBA area” in some cases to mean an area which can be likely to be referred to from a high-order apparatus. A PBA area not matched with the LBA based on the logical and physical conversion table 700 is referred to as an “ineffective PBA area” in some cases to mean that there is no probability of being referred to from a high-order apparatus.

Hitherto, the logical and physical conversion table 700 has been described.

Here, the block management information used to manage the block among the management information used by the NVM module 111 will be described.

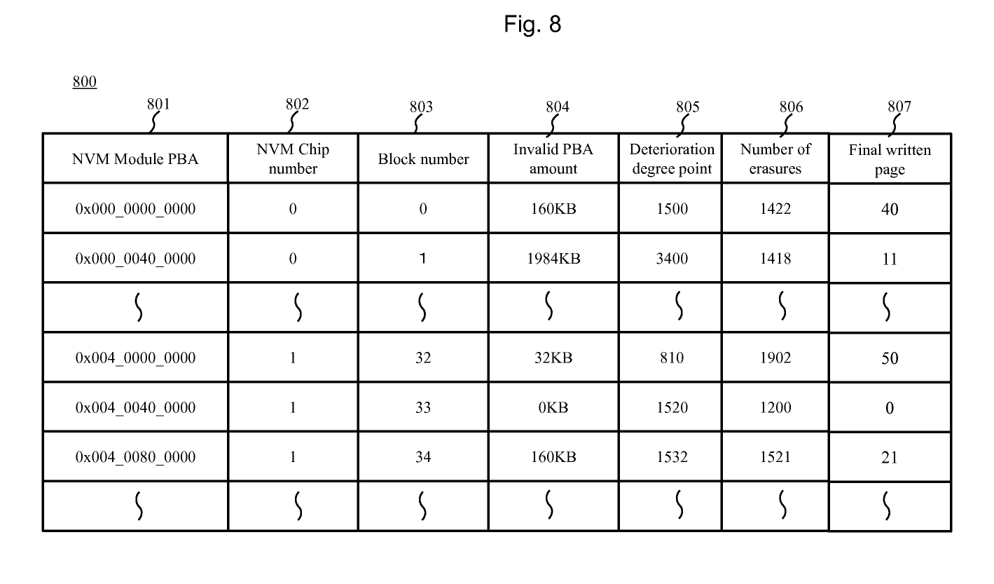

FIG. 8 is a diagram illustrating a block management table 800. The block management table 800 is created by the processor 215 and is stored in the DRAM 213. The block management table 800 includes an NVM module PBA 801, a chip number (NVM Chip) 802, a block number 803, an invalid PBA amount 804, a deterioration degree point 805, and the number of erasures 806, and a final written page 807 as fields.

The NVM module PBA 801 is a field in which PBA values used to uniquely designate the physical storage areas of all of the FMs 220 managed by the NVM module 111 are stored. In the block management information according to this embodiment, the PBAs are divided into units of blocks and are managed. That is, the block management table 800 includes entries of all of the blocks in the NVM module 111. Here, an example in which the head address of a block is stored as a PBA value will be described. For example, in the NVM module PBA 801, an entry with the PBA value, “0x000_{—}0000_{—}0000,” indicates a block that has a PBA range of “0x000_{—}0000_{—}0000” to “0x000_{—}003F_FFFF.”

The chip number 802 is a field in which chip numbers used to uniquely designate the chips of the FMs 220 in the NVM module 111 are stored, and indicates the FMs 220 including corresponding blocks.

The block number 803 is a field in which block numbers in the FMs 220 designated by the storage values of the chip numbers 802 are stored and indicates the corresponding blocks.

The invalid PBA amount 804 is a field in which the amounts of invalid PBAs in the corresponding blocks designated by the storage values of the block number 803 are stored in the FMs 220 designated by the storage values of the chip number 802. The amount of invalid PBA is the size of an invalid PBA area which may not be matched with the LBA in the logical and physical conversion table 700 in the corresponding block. The invalid PBA area inevitably occurs when pseudo-overwriting is realized in the FM 220 on which it is difficult to overwrite data. Specifically, when data of a certain LBA is updated, the processor 215 selects another unwritten PBA area, records the updated data on the selected PBA area, and rewrites the PBA corresponding to this LBA in the logical and physical conversion table 700 on the head address of the PBA area in which the updated data is recorded. At this time, by deleting the PBA area in which the data before the update is stored from the logical and physical conversion table 700, the matching with the LBA area is cancelled to be an invalid PBA area.

The deterioration degree point 805 is a field in which the deterioration degree point of a corresponding block designated by the NVM module PBA 801 is managed. This value indicates the degree of deterioration estimated for the corresponding block as a value corresponding to the number of erasures. A value of the deterioration degree point 805 is determined in a deterioration degree regular evaluation process to be described below and is updated when the corresponding block is evaluated through the deterioration degree regular evaluation process. The processor 215 increments the value of the deterioration degree point 805 by one whenever the corresponding block is erased. When a value stored in the deterioration degree point 805 exceeds a deterioration degree point upper limit value configured in advance in the system, the processor 215 disables the use of the corresponding block. Accordingly, even during a period of the deterioration degree regular evaluation process, the processor 215 can stop the use of the corresponding block of which the degree of deterioration exceeds the deterioration degree point upper limit value due to the erasure. Conversely, when the deterioration degree point of the corresponding block is less than the deterioration degree point upper limit value by the deterioration degree regular evaluation process, the processor 215 can resume the use of the corresponding block. The processor 215 performs block use selection (wear leveling) to level the values of the deterioration degree points 805.

The number of erasures 806 is a field in which the number of erasures of the corresponding block designated by the NVM module PBA 801 is managed. This value is incremented by one and is updated whenever the corresponding block is erased. The processor 215 does not make a comparison with the upper limit value, as in the value of the deterioration degree point 805, but counts the number of erasures as long as the corresponding block is used. When the quality of the corresponding block is poor and when value of the deterioration degree point 805 exceeds the deterioration degree point upper limit value in spite of the fact that the value of the number of erasures 806 is small, the corresponding block is managed as an unusable block. On the other hand, when the quality of the corresponding block is good, the corresponding block is used in spite of the fact that the value of the number of erasures 806 is large until the value of the deterioration degree point 805 exceeds the deterioration degree point upper limit value. In this embodiment, the example has been described in which the block management table 800 includes the column of the number of erasures 806. However, the processor 215 may not necessarily manage the number of erasures 806. When the deterioration degree point 805 is managed, the reliability of the FM 220 is maintained.

The final written page 807 indicates a page on which writing is performed finally in the corresponding block designated by the NVM module PBA 801. This is because the block is written in the page number order from the head page.

In the following description, blocks in which the use is not stopped among the blocks not matched to the LBAs based on the logical and physical conversion table 700 are referred to as preliminary areas. Blocks in which the value of the final written page 807 of the block management table 800 is 0 among the preliminary areas are referred to as unwritten blocks.

Hitherto, the block management table 800 has been described.

### (5) Deterioration Degree Regular Evaluation Process

Hereinafter, the deterioration degree regular evaluation process performed by the NVM module 111 will be described. In this embodiment, the NVM module 111 thoroughly examines the deterioration degree points of the physical storage areas managed by the NVM module 111 for each block during the operation (for example, the NVM module serves as the function of the storage device for the high-order storage controller 110 and continues reception and processing of Read/Write IO). At this time, many blocks in the NVM module 111 can be examined at a time. However, since the NVM module 111 needs to provide given storage areas to a high-order apparatus, the physical storage areas are examined in order for each given size (for example, 1% of all of the physical storage areas). That is, some of the storage areas are configured as examination targets of the deterioration degree points, and most of the other areas are controlled as normal storage areas.

In this embodiment, the processor 215 starts the deterioration degree regular evaluation process immediately after the operation of the NVM module 111. After the deterioration degree points of all of the blocks are evaluated, evaluation of the deterioration degree points of all of the blocks are instantly started again. By performing the evaluation of the deterioration degree points of all of the blocks without interruption in this way, the deterioration degree point of each block in the NVM module 111 is continuously evaluated. Further, the invention is not limited to the deterioration degree regular evaluation process performed without interruption, but all of the physical storage areas may be examined at any timing. For example, the processor 215 may start the evaluation of deterioration degree point at random or may perform the deterioration degree regular evaluation process when the number of erasures of the block of which the number of erasures is the largest among the blocks managed by the NVM module 111 reaches a given value. Further, the invention is not limited to the evaluation of the degree of deterioration for all of the blocks. The areas of certain predetermined blocks may be excluded from the evaluation target of the degree of deterioration.

Successive numbers which are continuing numbers are attached to all of the blocks in all of the FMs 220 in the NVM module 111.

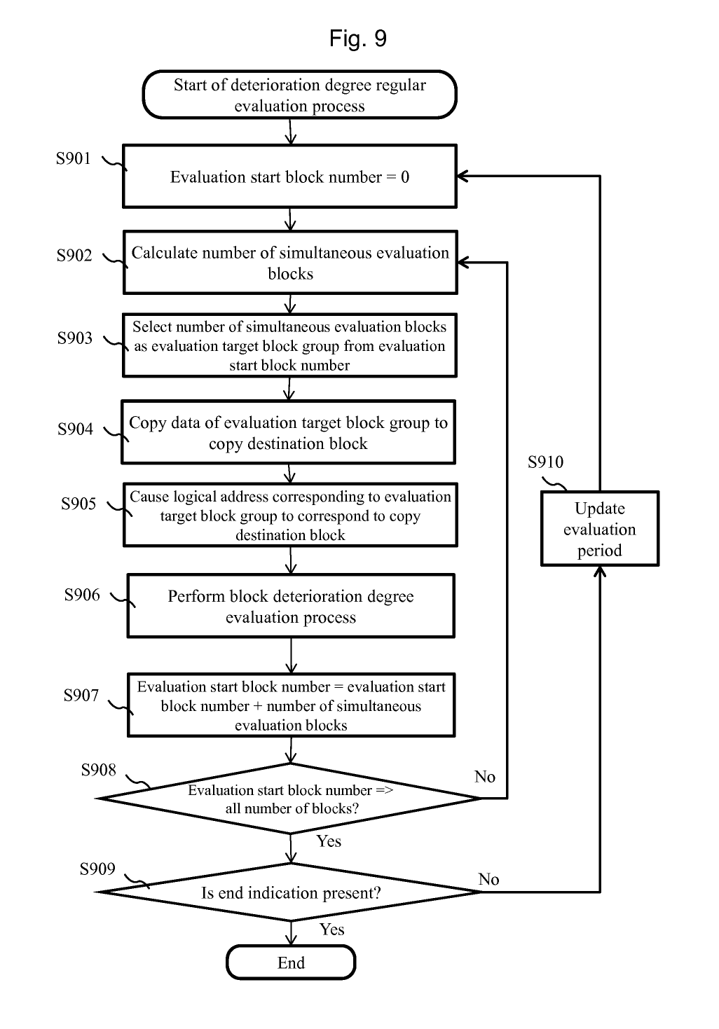

FIG. 9 is a flowchart of the deterioration degree regular evaluation process. First, the processor 215 configures the value of an evaluation start block number, which is a successive number indicating a start block of a block group evaluated at a time, to 0 (S901).

Thereafter, the processor 215 calculates a simultaneous evaluation block number which is the number of blocks to be evaluated simultaneously (S902). Specifically, the processor 215 calculates a quotient obtained by dividing the number of all of the blocks by an evaluation period and calculates a product of the quotient and an evaluation time as the simultaneous evaluation block number.

The evaluation period is a period for the evaluation of all of the blocks. The evaluation period is input and changed on the management screen displayed on the management apparatus 104. The management screen will be described below. In this embodiment, the example in which a manager changes the evaluation period with the management apparatus 104 has been described, but the invention is not limited to this embodiment. The evaluation period may be determined as a given value at the time of development.

An evaluation time is a time taken to perform the block deterioration degree evaluation process which is the evaluation of the blocks of the simultaneous evaluation block number. The evaluation time is changed due to the temperature. As the evaluation time, a time necessary for the previous block deterioration degree evaluation process is used. A first evaluation time is an initial configured value (for example, 4 days).

For example, when it is assumed that the size of all of the physical storage areas of the NVM module 111 is 2 TB, the areas are constituted by 2097152 blocks of 2 MB, the evaluation period is 200 days, and the evaluation time is 4 days, the simultaneous evaluation block number is calculated to “2097152/200×4=41943.04≈41944” blocks.

Thereafter, the processor 215 selects the blocks of the simultaneous evaluation block number starting from the evaluation start block number as an evaluation target block group to be evaluated at one time (S903). For example, when N is assumed to be the simultaneous evaluation block number, the processor 215 configures the blocks with the successive numbers from 0 to N−1 as an evaluation target block group when the evaluation start block number is 0. In the subsequent evaluation, the processor 215 configures the blocks with the successive numbers from N to 2N−1 as an evaluation target block group, since the evaluation start block number is N. In the following description, the evaluation (S903 to S907) of one evaluation target block group is referred to as an evaluation process in some cases.

Thereafter, the processor 215 selects the valid PBA areas in the evaluation target block group as copy source PBA areas, selects unwritten blocks necessary for copy of the copy source PBA areas as copy destination PBA areas from the blocks other than the evaluation target block group, and copies the data stored in the copy source PBA areas to the copy destination PBA areas (S904). In this embodiment, the processor 215 performs a reclamation process to ensure the unwritten blocks equal to or larger than a given amount in the NVM module 111. The processor 215 selects the copy destination PBA areas based on the values of the deterioration degree points 805 from the unwritten blocks pooled by an amount equal to or larger than a given amount. Further, the processor 215 may manage information indicating whether the consecutive number of each block or the block is the evaluation target block group.

Thereafter, the processor 215 performs change such that the copy destination PBA area corresponds to the LBAs corresponding to the copy source PBA areas in S904 based on the logical and physical conversion table 700 (S905). Thus, the PBA areas of the evaluation target block group become the invalid PBA areas which are not referred to from the high-order apparatus.

Thereafter, the processor 215 performs a block deterioration degree evaluation process of determining the deterioration degree point of each block in the evaluation target block group (S906). The details of the block deterioration degree evaluation process will be described below.

Thereafter, the processor 215 increments the evaluation start block number by the simultaneous evaluation block number to determine the subsequent evaluation target block group (S907).

Thereafter, the processor 215 determines whether the evaluation start block number reaches the number of all of the blocks in the NVM module 111 (S908). When the evaluation start block number is equal to or larger than the number of all of the blocks, the processor 215 determines that all of the managed blocks are evaluated and causes the process to transition to S909. Conversely, when the evaluation start block number is less than the number of all of the blocks, the processor 215 causes the process to transition to S903 to evaluate the subsequent evaluation target block group.

Thereafter, the processor 215 determines whether an end indication is received (S909). When the end indication is received, the processor 215 ends the deterioration degree regular evaluation process. The end indication may be input via the management apparatus 104 by the manager or may be issued by the management apparatus 104 under a predetermined condition. For example, when the number of operation years of the NVM module 111 reaches a given value, it may be determined that it is not necessary to further perform the deterioration degree regular evaluation process and the end may be indicated.

When the end indication is not received in S909, the processor 215 updates the evaluation period (S910). Here, when the manager changes the evaluation period via the management screen displayed on the management apparatus 104, the processor 215 uses the changed evaluation period in the subsequent deterioration degree regular evaluation process.

Hitherto, the deterioration degree regular evaluation process has been described.

By lengthening the evaluation period (for example, half year), the size of the evaluation target block group can be smaller than the size of the preliminary area or a sum size of the ensured unwritten blocks. Thus, it is possible to prevent the performance of the NVM module 111 from degrading due to the deterioration degree regular evaluation process. The processor 215 or the management apparatus 104 may store the upper limit value of the size of the evaluation target block group and determine the range of the evaluation period based on the upper limit value.

During the deterioration degree regular evaluation process, the evaluation target block group is not accessed by an IO request from the storage controller 110. When a first PBA area in the evaluation target block group corresponds to a specific LBA area, the data stored in the first PBA area can be copied to a second PBA area other than the evaluation target block group, as in S904 and S905 described above, and the specific LBA area corresponding to the first PBA area can correspond to the second PBA area. Thus, the LBA area in the logical and physical conversion table 700 does not correspond to the PBA area in the evaluation target block group and the first PBA area is concealed from the storage controller 110.

Here, an operation of the NVM module 111 receiving the IO request from the storage controller 110 during the deterioration degree regular evaluation process will be described. When receiving a read request from the storage controller 110, the processor 215 acquires the valid PBA areas corresponding to the LBA areas designated in the read request based on the logical and physical conversion table 700 and reads the data from the acquired PBA areas. Here, the read PBA areas are the PBA areas other than the evaluation target block group. When receiving a write request to write new data from the storage controller 110, the processor 215 acquires the unwritten PBA areas with a size designated in the write request from the areas other than the evaluation target block group based on the block management table 800, writes the new data on the acquired PBA areas, and causes the written PBA areas to correspond to the LBAs designated in the write request. Here, the PBA areas on which the new data is written are the PBA areas other than the evaluation target block group. When receiving a write request to write updated data from the storage controller 110, the processor 215 acquires the unwritten PBA areas with a size designated in the write request from the blocks other than the evaluation target block group, writes the updated data on the acquired PBA areas, causes the PBA areas subjected to the writing to correspond to the LBAs designated in the write request, and changes the PBA areas in which the data before the update is stored to the invalid PBA areas. Here, the PBA areas on which the updated data is written are the PBA areas other than the evaluation target block group.

### (6) Block Deterioration Degree Evaluation Process

Hereinafter, the details of the block deterioration degree evaluation process in S906 of the above-described deterioration degree regular evaluation process will be described.

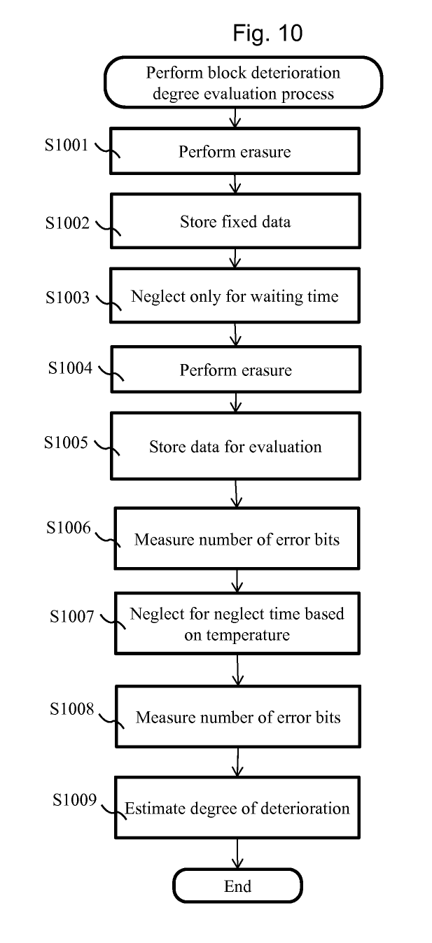

FIG. 10 is a flowchart of the block deterioration degree evaluation process. First, the processor 215 erases all of the blocks in the evaluation target block group (S1001). Here, since all of the blocks of the evaluation target block group are the invalid PBA areas and are areas which are not referred to from the high-order apparatus, the NVM module 111 can delete the evaluation target block group.

Thereafter, the processor 215 records fixed data determined in advance on the evaluation target block group (S1002). Here, the “fixed data” refers to data for which a given amount of electron is injected into cells in the FM 220. In the FM 220, the amounts of electron injected into the cells differ according to the value of the data to be written. In this embodiment, writing of 0 as a bit value is assumed to be the injection of the given amount of electron into the cells and the fixed data is data in which the evaluation target block group is filled with the value 0. The invention is not limited to the fixed data.

Thereafter, the processor 215 performs neglect only for a predetermined standby time (S1003).

S1002 and S1003 are performed for the evaluation in stable state of the respective cells by constantly unifying the deterioration degree evaluation conditions of the respective cells.

Hereinafter, stabilization of the deterioration degree evaluation conditions will be described.

In the cells in the FM 220, a data retention performance is known to be considerably varied by a rewrite interval which is a time interval of rewrite at the previous plurality of times. For example, when the rewrite interval is short at previous three times, an error bit increase amount per unit time increases for data to be subsequently written. This phenomenon is caused due to an amount of trapped electron (electrons trapped in an insulation film) of a cell. This is because when the rewrite interval is short, the amount of trapped electron of a cell increases and the amount of electron injected into a floating gate of the cell decreases. Since the trapped electrons leaks from the cell in a shorter time than the electrons within the floating gate, the cell state is changed more easily in a short time as the amount of trapped electron is larger. For this reason, in the evaluation target block group, the error bits may increase falsely when the write interval is short at the recent rewrite intervals of the previous plurality of times.

The influence of the data retention performance of the trapped electrons can be reduced to some extent by neglect for several hours to several tens of hours. Since it is necessary to interrupt writing into the cell for a given time in order to reduce the trapped electrons of the cell, the processor 215 performs S1003. Since the injection of an amount of electron equal to or larger than a given amount of electron into the floating gate of the cell during the standby time results in the decrease in the trapped electron, the processor 215 performs S1002. The decrease in the trapped electrons is slowed over time. That is, the amount of trapped electron decreased during the neglect for subsequent 1 hour is less than the amount of trapped electron decreased during the neglect for 1 hour.

In this embodiment, the stable evaluation can be achieved by decreasing the trapped electrons of the cells of the evaluation target block group by the neglect only for the standby time after the writing of the fixed data on the cells and unifying the deterioration degree evaluation conditions of the respective cells of the evaluation target block group. Further, S1002 and S1003 are not essential steps in the block deterioration degree evaluation process. For example, an NVM module controlled such that a short rewrite interval is not repeated can stably evaluate the deterioration degree point even when S1002 and S1003 are not performed.

Thereafter, the processor 215 erases the evaluation target block group on which the fixed data is written (S1004). Thus, data can newly be written on the evaluation target block group. Further, when a storage element capable of performing overwriting is used instead of the FM 220, this process is not necessary.

Thereafter, the processor 215 writes evaluation data (S1005). As described above, in the FM 220, the number of error bits occurring in the recorded data increases over time after the recording of the data. An increase ratio of the error bits which is the increase number of error bits per unit time of a certain block is changed not only due to the cumulative number of erasures or a previous rewrite interval of the block but also due to data to be recorded. The evaluation data is, for example, data in which bit values are alternately changed as “10101010” and is data in which bit values recorded in adjacent cells are different from each other. The increase ratio of the error bits of a block at the time of the recording of the evaluation data is considerably higher than the increase ratio of the error bits of the block at the time of recording of random data. Alternatively, the number of error bits after a neglect time of a block elapses at the time of the recording of the evaluation data is higher than the number of error bits after a neglect time of the block elapses at the time of the recording of random data. In this embodiment, by recording data for which the increase ratio of the error bits is considerably high, the number of error bits occurring during the subsequent neglect can be increased, and thus accuracy of the deterioration degree point can be improved.

Thereafter, the processor 215 measures a first error bit number which is the number of error bits occurring in each block in the evaluation target block group immediately after the recording of the data (S1006). The measurement of the number of error bits is performed, for example, by counting the bit values corrected by an ECC circuit. Thus, the number of error bits occurring at the time of the write can be measured.

In this embodiment, the error bits are increased by using a method different from a normal read method as an evaluation read method of measuring the number of error bits. Specifically, the processor 215 increases the error bits by causing an evaluation read threshold voltage to be higher than a normal read threshold voltage.

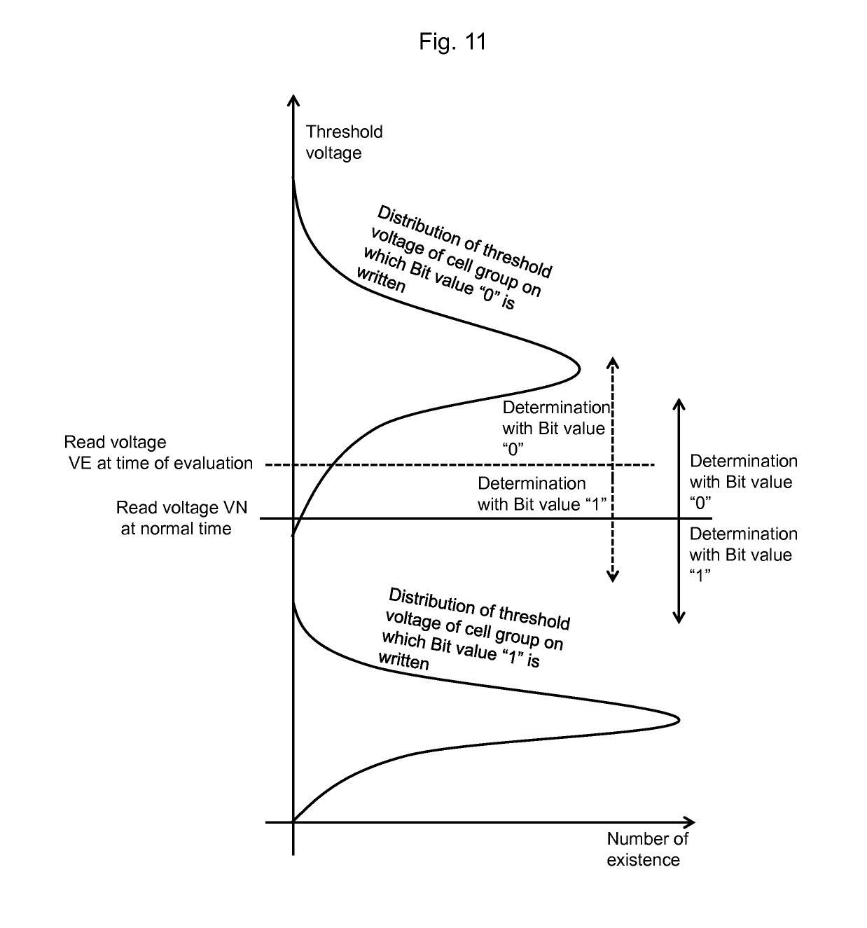

FIG. 11 is a diagram illustrating control of a read voltage at the time of the evaluation. In the drawing, the vertical axis represents a threshold voltage of the cells in the FM 220 and the horizontal axis represents the number of existence of the cells with each threshold value. The drawing illustrates a threshold voltage distribution DO of a cell group on which a bit value “0” is written and a threshold voltage distribution D1 of a cell group on which a bit value “1” is written. The drawing also illustrates a normal read voltage VN and an evaluation read voltage VE higher than VN. At the normal time, the FM 220 determines that the bit value is “0” when the threshold value of the cells is higher than VN, and determines that the bit value is “1” when the threshold voltage of the cells is lower than VN. The threshold voltage of the cells in a part of the lower end of the threshold voltage distribution of the cell group on which the bit value “0” is written is lower than VN. In the cells of the part, an error bit may occur since a bit value is determined to be “1” at the time of the read in spite of the fact that “0” is recorded as the bit value. Normally, the threshold voltage of the cells degrades as time elapses. Therefore, the number of cells in which the bit value is read as “1” gradually increases in the cell group on which the bit value “0” is written.

Thus, since the number of error bits detected using VN is considerably small, accuracy of the deterioration degree point determined using VN is low. Thus, the processor 215 uses VE higher than VN in the reading of the evaluation data. That is, in the reading of the evaluation data, the FM 220 determines that the bit value is “0” when the threshold voltage of the cells is higher than VE, and determines that the bit value is “1” when the threshold voltage of the cells is lower than VE. Thus, the number of error bits can be increased compared to the case in which VN is used. Since many error bits can be obtained through this control compared to the normal read method, the accuracy of the deterioration degree point can be improved. In this embodiment, VE higher than VN has been used at the time of the evaluation, but the invention is not limited to this method. To obtain the error bits, VN may be used.

Thereafter, the processor 215 performs neglect only for the neglect time (S1007). In this embodiment, the processor 215 changes the neglect time based on the temperature. The processor 215 monitors the temperature of the FM 220 to which the evaluation target block group belongs and configures the neglect time so that the neglect time is shorter as the temperature is higher. For example, when 2 days are configured as the neglect time in an environment of the room temperature of 25 degrees, 1 day is configured as the neglect time in an environment of 50 degrees. Since the evaluation time is a sum of the standby time and the neglect time, the evaluation time is also changed by changing the neglect time under the influence of the temperature. In S902, the processor 215 equalizes the evaluation period to a designated value by adjusting the simultaneous evaluation block number according to the change in the evaluation time.

Here, the reason for changing the neglect time according to the temperature will be described. In the FM 220, an increase in the error bits after the recording of the data is known to be accelerated due to an increase in temperature. For example, in a certain FM 220, the number of error bits of each block is increased by average 3 bits when 30 days pass in the environment of 25° C. The number of error bits of each block is increased by average 3 bits when 5 days pass in the environment of 50° C. The influence of the acceleration of the increase in the error bits due to the temperature is various depending on a manufacturing vendor of the FM 220 and a manufacturing process. In this embodiment, by examining the influence of the acceleration of the increase in the error bits due to the temperature of the FM 220 before shipment of the NVM module 111 and storing the examination information in the NVM module 111, the processor 215 changes the neglect time according to the change in the temperature. In this embodiment, the deterioration degree point is determined by the error bit increase amount per unit time. Here, the unit time is the neglect time and the neglect time is changed according to the temperature. In an environment in which the temperature of the FM 220 is constantly estimated, it is not necessary to change the neglect time according to the temperature and the neglect time may be constant. Further, the processor 215 may perform temperature correction of the error bit increase amount by causing the neglect time to be constant and multiplying the measured error bit increase amount by a coefficient based on the temperature.

Thereafter, the processor 215 measures a second error bit number which is the number of error bits occurring in each block in the evaluation target block group after the neglect time elapses (S1008). Here, the processor 215 increases the number of error bits by using the same read method as the method of S1006. However, the invention is not limited to this method, as in S1006.

Thereafter, the processor 215 calculates a value obtained by subtracting the first error bit number from the second error bit number with regard to each block in the evaluation target block group as the error bit increase amount, and estimates the deterioration degree point from the error bit increase amount (S1009).

Here, information used to estimate the deterioration degree point in S1009 will be described.

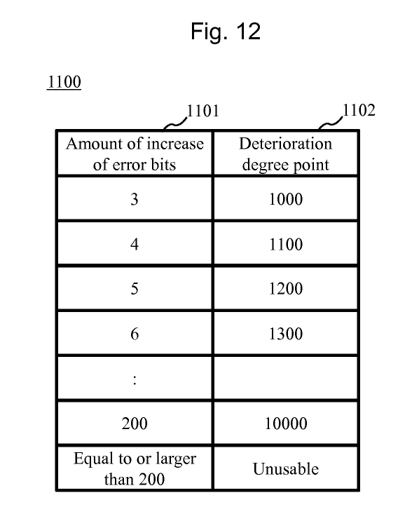

FIG. 12 is a diagram illustrating a deterioration degree point estimation table 1100. The deterioration degree point estimation table 1100 is stored in the DRAM 213 and manages a correspondence relation between an error bit increase amount 1101 and a deterioration degree point 1102. In S1009, the processor 215 searches for a row corresponding to a value described in the error bit increase amount 1101 with reference to the deterioration degree point estimation table 1100 and acquires the value of the deterioration degree point 1102 in the row. The deterioration degree point estimation table 1100 is created by examining the characteristics of the FM 220 before the shipment of the NVM module 111.

For example, when an error bit increase amount of a certain block in the evaluation target block group is “4,” the processor 215 acquires a value “1100” of the deterioration degree point 1102 in the row corresponding to the value of the error bit increase amount 1101 from the deterioration degree point estimation table 1100. This value is the deterioration degree point of the corresponding block.

The processor 215 updates the deterioration degree point of the corresponding block by writing the acquired deterioration degree point on the deterioration degree point 805 of the corresponding block in the block management table 800 with regard to each block in the evaluation target block group.

In this embodiment, the error bit increase amount during the neglect time has been calculated using the difference between the first error bit number immediately after the writing and the second error bit number after the elapse of the neglect time. However, when the first error bit number can be ignored, S1006 may not be performed. Using a first neglect time and a second neglect time longer than the first neglect time, the number of error bits after elapse of the first neglect time from writing of the evaluation data may be referred to as the first error bit number and the number of error bits after elapse of the second neglect time from the writing of the evaluation data may be referred to as the second error bit number.

For example, the deterioration degree point is determined based on the number of error bits after elapse of a predetermined retention time (for example, 3 months) from recording of data. For example, the deterioration degree point upper limit value is the maximum deterioration degree point for which the number of error bits after elapse of a retention time from recording of data is within a correctable range by an ECC. In this case, the deterioration degree point is estimated by estimating an error bit increase ratio (error bit increase speed) which is the error bit increase amount per unit time and estimating the number of error bits after elapse of a predetermined time using the error bit increase ratio. When the first error bit number immediately after the writing is not ignorable, the first error bit number and the second error bit number are used. Therefore, the estimation accuracy of the error bit increase ratio can be improved compared to the case in which only the second error bit number is used. Accordingly, the estimation accuracy of the number of error bits after the elapse of the retention time can be improved. Thus, the estimation accuracy of the deterioration degree point can be improved.

Hitherto, the block deterioration degree evaluation process has been described.

### (7) Wear Leveling

Hereinafter, the wear leveling using the deterioration degree point will be described.

Here, dynamic wear leveling will be described.

In the reclamation process, for example, when the number of unwritten blocks is less than a given number, the processor 215 selects the blocks with an invalid PBA amount relatively larger than the other blocks as copy source blocks (first areas) among the blocks storing the valid data based on the block management table 800. The processor 215 selects the blocks with deterioration degree point relatively smaller than the other blocks among the unwritten blocks other than the evaluation target block group as copy destination blocks (second areas) based on the block management table 800. Thereafter, the processor 215 copies the valid data in the copy source blocks to the copy destination blocks, configures the PBA areas of the copy sources as invalid PBA areas, erases the blocks which are all the invalid PBA areas to generate the unwritten blocks, and causes the LBA areas corresponding to the copy source blocks in the logical and physical conversion table 700 to correspond to the PBA areas of the copy destination blocks. Here, the processor 215 may select the copy source blocks in an order in which the invalid PBA amount is large.

In S904 described above, the processor 215 selects the blocks with the relatively smaller deterioration degree point from the unwritten blocks as the copy destination blocks based on the block management table 800.

Here, static wear leveling will be described.

For example, the processor 215 periodically selects the blocks with the deterioration degree point relatively smaller than the other blocks as copy source blocks (third areas) from the blocks other than the unwritten blocks based on the block management table 800, irrespective of the invalid PBA amount. Further, the processor 215 selects copy destination blocks (fourth areas) among the unwritten blocks other than the evaluation target block group based on the block management table 800. Thereafter, the processor 215 copies the data of the copy source blocks to the copy destination blocks, erases the copy source blocks to generate the unwritten blocks, and causes the LBA areas corresponding to the copy source blocks in the logical and physical conversion table 700 to correspond to the copy destination blocks.

In the static wear leveling, for example, the processor 215 may selects the blocks with the smallest deterioration degree point as the copy source blocks or may select the blocks with the deterioration degree point lower than an average value of the deterioration degree points by equal to or higher than a predetermined value as the copy source blocks. Further, the processor 215 may select the unwritten blocks with the largest deterioration degree point as the copy destination blocks or may select the unwritten blocks with the deterioration degree point larger than an average value of the deterioration degree points by equal to or higher than a predetermined value as the copy destination blocks.

When an NVM module to which the invention is not applied performs wear leveling based on the number of erasures, the blocks with the small number of erasures may be used in spite of the fact that the quality is poor. For example, although the number of erasures of a certain block is sufficiently smaller than the erasure number upper limit value due to a variation in the deterioration of the blocks, the number of error bits of this block reaches the error bit number upper limit value, and thus the use of this block may be stopped in some cases. Thus, the preliminary areas may decrease and the performance of the NVM module may be degraded. Further, the use of the block may be stopped in a period shorter than the device life span of the FM.

According to the wear leveling based on the deterioration degree point of this embodiment, the number of erasures of the blocks with good equality can be enlarged more than the number of erasures of the blocks with poor quality. Thus, the decrease in the preliminary areas can be suppressed and the performance of the NVM module 111 can be suppressed from degrading. Thus, the blocks with good quality can be used in some cases up to the number of erasures larger than the erasure number upper limit value. Accordingly, the average number of erasures of all of the blocks when the wear leveling is performed based on the deterioration degree points can be enlarged more than the average number of erasures of all of the blocks when the wear leveling is performed based on the number of erasures.

### (8) Management Screen

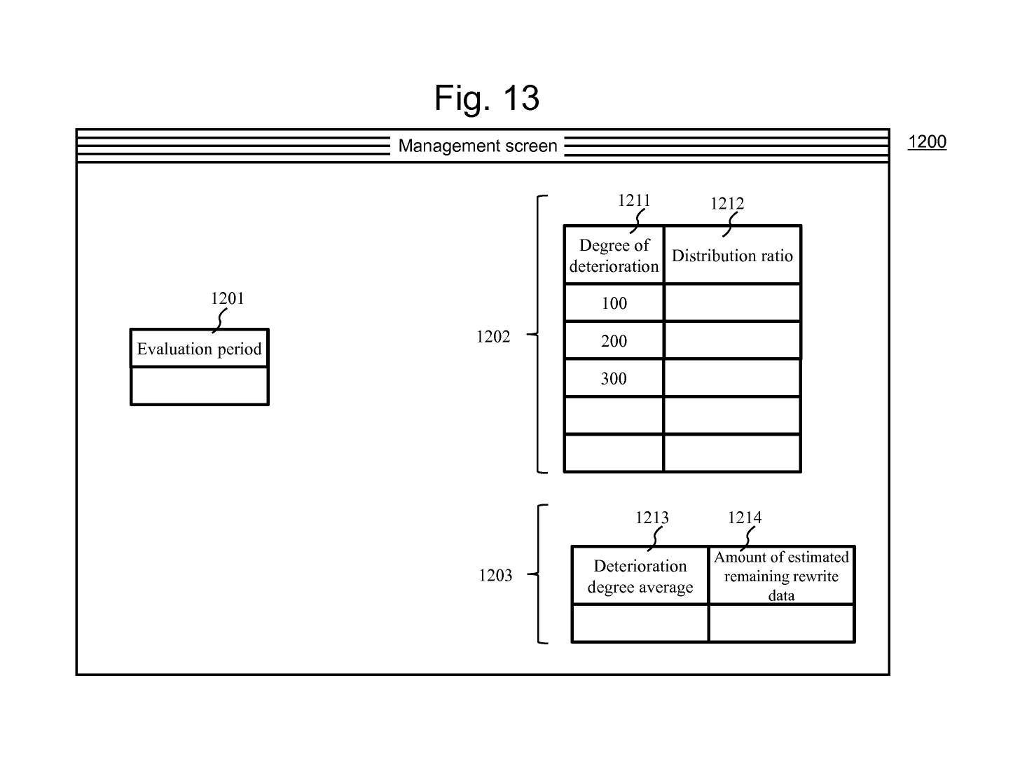

FIG. 13 is a diagram illustrating a management screen. The management apparatus 104 displays a management screen 1200 in response to an indication from the manager. The management screen 1200 includes an evaluation period input unit 1201, a deterioration degree distribution display portion 1202, and a status display unit 1203. The management apparatus 104 can display the management screen 1200 in correspondence with each of a plurality of groups of the NVM modules 111 in the storage apparatus 101. For example, the management apparatus 104 displays the management screen 1200 in units of RAID GROUP configured by the plurality of NVM modules 111. The invention is not limited to the units of management. The management screen 1200 may be a screen on which an evaluation period is changed for each NVM module 111 or may be a screen on which the status of the deterioration degree points is displayed for each NVM module 111.

The evaluation period input unit 1201 is an input field to which the evaluation period of the deterioration degree regular evaluation process is input. When the evaluation period is input to the evaluation period input unit 1201 by the manager, the management apparatus 104 transmits the evaluation period to all of the NVM modules 111 constituting target RAID Group. In the NVM modules 111 receiving the evaluation period, the evaluation period is changed into a received value.

The deterioration degree distribution display portion 1202 indicates a deterioration degree point distribution of all of the blocks in the NVM modules 111 constituting target RAID Group. The deterioration degree distribution display portion 1202 includes the degree of deterioration 1211 and a distribution ratio 1212 as display fields. Each of the values of the degree of deterioration 1211 is the deterioration degree point. The distribution ratio 1212 indicates a ratio of the blocks having the deterioration degree points contained in a predetermined range centering on the values of the degree of deterioration 1211 to the number of all blocks. The distribution ratio 1212 may be the number of blocks having the deterioration degree points contained in a corresponding predetermined range. The manager can comprehend the status of the deterioration degree points, viewing the deterioration degree distribution display portion 1202, and thus can confirm whether deterioration equal or larger than assumption of the manager occurs.

The status display unit 1203 includes a deterioration degree average 1213 and an estimated remaining rewrite data amount 1214 as display fields. The deterioration degree average 1213 indicates an average of the deterioration degree points of all of the blocks in the NVM modules 111 constituting target RAID Group. The manager can estimate the remaining life span of target RAID Group, viewing the deterioration degree average 1213.

The estimated remaining rewrite data amount 1214 indicates a sum value of the amounts of the remaining rewrite data of the NVM modules 111 constituting target RAID Group. The value of the estimated remaining rewrite data amount 1214 may be a sum value of the values obtained by subtracting the deterioration degree points from the deterioration degree point upper limit value with regard to the respective blocks or may be a value obtained by multiplying the sum value by a block size. The manager can recognize the amount of data writable on target RAID Group, viewing the estimated remaining rewrite data amount 1214.

Hitherto, the management screen has been described.

Hereinafter, advantages of this embodiment will be described.

In this embodiment, the processor 215 conceals the evaluation target block group from a high-order apparatus and examines the degree of deterioration of each block in the evaluation target block group by changing the logical and physical conversion table 700 without interruption of the access from the high-order apparatus. The processor 215 thoroughly examines the deterioration degree of all of the physical storage areas or the physical storage areas (plurality of specific physical storage areas) within a predetermined range during the operation by repeating this operation periodically. The processor 215 can thoroughly evaluate the degree of deterioration of the blocks within the predetermined range through this operation.

The evaluation result is strongly influenced by the rewrite interval before the evaluation. For example, when the rewrite interval immediately before the evaluation of the deterioration degree point of a certain block is short, the deterioration degree point of this block is considerably increased in some cases. Thus, before the evaluation of the deterioration degree point, the processor 215 writes the fixed data and performs the erasure after the neglect only for the standby time. Through this operation, the influence of the rewrite interval before the evaluation can be reduced and the degree of deterioration can be stably evaluated.

Thereafter, the processor 215 records data in which the error bits easily occur and acquires the number of error bits immediately after the writing. Thereafter, the processor 215 acquires the number of error bits again after the neglect time increasing or decreasing according to the environment temperature of the FM 220. Thereafter, the processor 215 comprehends the increase tendency of the error bits by comparing the number of error bits immediately after the writing with the number of error bits after the neglect time, and estimates the degree of deterioration of the block based on the increase tendency. Through this operation, the degree of deterioration can be managed based on the increase tendency of the error bits, and thus each block can be used up to the number of rewriting according to the degree of deterioration.

The processor 215 determines the deterioration degree points based on the increase tendency of the error bits and performs control such that the blocks with the relatively smaller deterioration degree point is preferentially used to level the deterioration degree points. Thus, since the erasure is performed relatively more times in the blocks with good quality and the erasure is performed relatively less times in the blocks with poor quality, the reliability of the device can be improved.

In the related art, the erasure number upper limit value is uniformly determined on the assumption that the blocks have naturally poor quality and the blocks deteriorate under the worst use environment. Further, even the blocks that have good quality and are hard to deteriorate are configured to be unusable, when the number of erasures exceeds the erasure number upper limit value. For this reason, the number of erasures which can be performed in the entire NVM module may be less than the actual capability. However, as in this embodiment, the control of allowing the memories with good quality to perform a larger number of erasures can be realized by determining whether the blocks are usable based on the upper limit value of the deterioration degree points. Thus, since more erasures as the entire NVM module can be performed, the device life span of the NVM module can be prolonged.

The technologies described in the above-described embodiments can be expressed as follows.

### (Representation 1)

A storage device includes: a non-volatile memory configured to include a plurality of physical storage areas; and a controller configured to be coupled to the non-volatile memory. The controller calculates the degree of deterioration of each of a plurality of specific physical storage areas among the plurality of physical storage areas by performing one at a time an evaluation process of evaluating the plurality of specific physical storage areas over all of the plurality of specific physical storage areas and determines whether to use the corresponding physical storage areas based on the calculated degree of deterioration. In the evaluation process, the controller selects a part of the plurality of specific physical storage areas as a physical storage area group in a predetermined order of the physical storage areas, moves data in the physical storage area group, erases the physical storage area group, writes predetermined evaluation data in the physical storage area group, reads the evaluation data from the physical storage area group after elapse of a stored neglect time from writing the evaluation data, and calculates the degree of deterioration of a designated area which is each physical storage area in the physical storage area group based on the read evaluation data.

### (Representation 2)

In the storage device described in Representation 1, the controller may repeat the evaluation process on the plurality of specific physical storage areas.

### (Representation 3)

In the storage device described in Representation 2, the controller may select the physical storage areas of a stored number of physical storage areas as the physical storage area group among the plurality of specific physical storage areas in a predetermined order.

### (Representation 4)

In the storage device described in Representation 3, the controller may measure the number of error bits after neglect, which is the number of error bits of the designated area, based on a read result of the evaluation data after the elapse of the neglect time and calculate the degree of deterioration of the designated area based on the number of error bits after the neglect.

### (Representation 5)

In the storage device described in Representation 4, the controller may store correspondence information used to cause a logical address designated by an IO request to correspond to a physical address in the plurality of specific physical storage areas. When there is a valid area which is an area storing valid data in the physical storage area group before erasure of the physical storage area group, the controller may select an unwritten physical storage area other than the physical storage area group in the plurality of specific physical storage areas as a substitute area, copy the valid data in the valid area to the substitute area, and cause a logical address corresponding to the valid area in the correspondence information to correspond to the substitute area.

### (Representation 6)

In the storage device described in Representation 5, after the writing of the evaluation data and before the elapse of the neglect time, the controller may read the evaluation data from the physical storage area group, measure the number of error bits after recording, which is the number of error bits of the designated area, based on a read result of the evaluation data before the elapse of the neglect time, calculate a value obtained by subtracting the number of error bits after the recording from the number of error bits after the neglect time as an error bit increase amount, and calculate a degree of deterioration of the designated area based on the error bit increase amount.

### (Representation 7)

In the storage device described in Representation 6, the degree of deterioration of the designated area may be a value obtained by converting deterioration of the designated area into the number of erasures. The controller may store relation information indicating a relation between the error bit increase amount and the degree of deterioration of the designated area, and convert the error bit increase amount into the degree of deterioration of the designated area based on the relation information.

### (Representation 8)

In the storage device described in any one of Representations 1 to 7, the controller may write predetermined fixed data on the physical storage area group after the erasure of the physical storage area group and before the writing of the evaluation data, and may erase the physical storage area group after a predetermined standby time elapses.

### (Representation 9)

In the storage device described in Representation 6, the controller may measure a temperature of the non-volatile memory and change the neglect time based on the temperature.

### (Representation 10)

In the storage device described in any one of Representations 1 to 7, the controller may read the evaluation data from the designated area by using a read voltage higher than a read voltage used when data designated by a read request is read from the non-volatile memory.

### (Representation 11)

In the storage device described in Representation 4, the number of error bits after the neglect occurring due to the writing of the evaluation data may be larger than the number of error bits after the neglect occurring due to writing of random data.

### (Representation 12)

In the storage device described in Representation 5, the controller may select a physical storage area storing a valid data in the plurality of specific physical storage areas as a first area, select a physical storage area, which has a degree of deterioration lower than a degree of deterioration of the other physical storage areas, as a second area from unwritten physical storage areas other than the physical storage area group in the plurality of specific physical storage areas, copy data in the first area to the second area, erases the first area, and cause a logical address corresponding to the first area in the correspondence information to correspond to the second area.

### (Representation 13)

In the storage device described in Representation 5, the controller may select a physical storage area, which has a degree of deterioration lower than a degree of deterioration of the other physical storage areas, as a third area from physical storage areas storing valid data in the plurality of specific physical storage areas, select an unwritten physical storage area other than the physical storage area group in the plurality of specific physical storage areas as a fourth area, copy data in the third area to the fourth area, erase the third area, and cause a logical address corresponding to the third area in the correspondence information to correspond to the fourth area.

### (Representation 14)

In the storage device described in any one of Representations 1 to 7, each of the plurality of specific physical storage areas may be a physical block with a predetermined size. The controller may erase data in units of the physical blocks.

### (Representation 15)

There is provided a storage device control method of controlling a storage device including a non-volatile memory configured to include a plurality of physical storage areas and a controller configured to be coupled to the non-volatile memory. The method includes: operating the controller to calculate the degree of deterioration of each of a plurality of specific physical storage areas by performing an evaluation process of evaluating the plurality of specific physical storage areas among the plurality of physical storage areas part by part on all of the plurality of specific physical storage areas; and to determine whether to use the corresponding physical storage areas based on the calculated degree of deterioration. In the evaluation process, the controller selects a part of the plurality of specific physical storage areas as a physical storage area group in a predetermined order of the physical storage areas, moves data in the physical storage area group, erases the physical storage area group, writes predetermined evaluation data in the physical storage area group, reads the evaluation data from the physical storage area group after a stored neglect time elapses from writing the evaluation data, and calculates the degree of deterioration of a designated area which is each physical storage area in the physical storage area group based on the read evaluation data.

The terms in the above description will be described. The storage device corresponds to the NVM module 111 or the like. The physical storage area corresponds to the physical block or the like. The non-volatile memory corresponds to the FM 220 or the like. The controller corresponds to the FM controller 210 or the like. The degree of deterioration corresponds to the deterioration degree point or the like. The predetermined order corresponds to the successive number or the like. The physical storage area group corresponds to the evaluation target block group or the like. The number of physical storage areas corresponds to the simultaneous evaluation block number or the like. The correspondence information corresponds to the logical and physical conversion table 700 or the like. The number of error bits after the recording corresponds to the first error bit number or the like. The number of error bits after the neglect corresponds to the second error bit number or the like. The relation information corresponds to the deterioration degree point estimation table 1100 or the like.

### REFERENCE SIGNS LIST

101 Storage apparatus
103 Host
104 Management apparatus
107 Disk interface
110 Storage controller
111 NVM module
118 Management information
121 Processor
122 Inter-connect switch
123 Disk interface
124 Host interface
125 Memory
210 FM controller
211 Disk interface
213 RAM
214 Switch
215 Processor
216 Data buffer
217 FM interface
220 FM
700 Logical and physical conversion table
800 Block management table
1100 Deterioration degree point estimation table
1200 Management screen

1. A storage device comprising:
a non-volatile memory configured to include a plurality of physical storage areas; and
a controller configured to be coupled to the non-volatile memory, wherein the controller:
calculates a degree of deterioration of each of a plurality of specific physical storage areas among the plurality of physical storage areas by performing an evaluation process of evaluating the plurality of specific physical storage areas part by part over all of the plurality of specific physical storage areas,
determines whether to use corresponding physical storage areas based on the calculated degree of deterioration,
in the evaluation process, the controller:
selects physical storage areas of a stored number of physical storage areas as a physical storage area group in a predetermined order,
moves data in the physical storage area group,
erases the physical storage area group,
writes predetermined evaluation data on the physical storage area group,
reads the evaluation data from the physical storage area group after elapse of a stored neglect time from the time of writing the evaluation data, and
calculates the degree of deterioration of a designated area, which is each physical storage area in the physical storage area group based on the read evaluation data,
repeats the evaluation process on all of the plurality of specific physical storage areas,
measures a number of error bits after neglect, which is the number of error bits of the designated area, based on a read result of the evaluation data after the elapse of the neglect time and calculates the degree of deterioration of the designated area based on the number of error bits after the neglect,
stores correspondence information used to cause a logical address designated by an TO request to correspond to a physical address in the plurality of specific physical storage areas,
when there is a valid area, which is an area storing valid data in the physical storage area group before erasure of the physical storage area group, the controller:
selects an unwritten physical storage area other than the physical storage area group as a substitute area from the plurality of specific physical storage areas,
copies the valid data in the valid area to the substitute area, and
causes a logical address corresponding to the valid area in the correspondence information to correspond to the substitute area,
selects a physical storage area storing a valid data in the plurality of specific physical storage areas as a first area,
selects a physical storage area, which has a degree of deterioration lower than a degree of deterioration of the other physical storage areas, as a second area from unwritten physical storage areas other than the physical storage area group in the plurality of specific physical storage areas,
copies data in the first area to the second area,
erases the first area, and
causes a logical address corresponding to the first area in the correspondence information to correspond to the second area.

2-5. (canceled)

6. The storage device according to claim 1, wherein, after the writing of the evaluation data and before the elapse of the neglect time, the controller reads the evaluation data from the physical storage area group, measures the number of error bits after recording, which is the number of error bits of the designated area, based on a read result of the evaluation data before the elapse of the neglect time, calculates a value obtained by subtracting the number of error bits after the recording from the number of error bits after the neglect as an error bit increase amount, and calculates the degree of deterioration of the designated area based on the error bit increase amount.

7. The storage device according to claim 6, wherein
the degree of deterioration of the designated area is a value obtained by converting deterioration of the designated area into the number of erasures, and wherein
the controller stores relation information indicating a relation between the error bit increase amount and the degree of deterioration of the designated area and converts the error bit increase amount into the degree of deterioration of the designated area based on the relation information.

8. The storage device according to claim 1, wherein the controller writes predetermined fixed data on the physical storage area group after the erasure of the physical storage area group and before the writing of the evaluation data, and erases the physical storage area group after a predetermined standby time elapses.

9. The storage device according to claim 1, wherein the controller measures a temperature of the non-volatile memory and changes the neglect time based on the temperature.

10. The storage device according to claim 1, wherein the controller reads the evaluation data from the designated area by using a read voltage higher than a read voltage used when data designated by a read request is read from the non-volatile memory.

11. The storage device according to claim 1, wherein the number of error bits after the neglect occurring due to the writing of the evaluation data is larger than the number of error bits after the neglect occurring due to writing of random data.

12. (canceled)

13. The storage device according to claim 1, wherein the controller selects a physical storage area, which has a degree of deterioration lower than a degree of deterioration of the other physical storage areas, as a third area from physical storage areas storing valid data in the plurality of specific physical storage areas, selects an unwritten physical storage area other than the physical storage area group in the plurality of specific physical storage areas as a fourth area, copies data in the third area to the fourth area, erases the third area, and causes a logical address corresponding to the third area in the correspondence information to correspond to the fourth area.

14. The storage device according to claim 1, wherein
each of the plurality of specific physical storage areas is a physical block with a predetermined size, and
the controller erases data in units of the physical blocks.

15. (canceled)
